(19) United States
(12) Patent Application Publication
(10) Pub. No.: US 2025/0104184 A1
(43) Pub. Date: Mar. 27, 2025

(54) METHODS AND TECHNIQUES OF RESIZING OF SCINTIGRAPHY IMAGES

(71) Applicant: Jubilant Draximage, Inc., Montreal (CA)

(72) Inventors: Eric Moulton, Montreal (CA); Siraj Ghassel, Ottawa (CA); Jochen Lang, Montreal (CA); Ran Klein, Ottawa (CA); Indranil Nandi, Yardley, PA (US)

(73) Assignees: Jubilant Draximage, Inc., Montreal (CA); Ottawa Hospital Research Institute, Ottawa (CA)

(21) Appl. No.: 18/892,028

(22) Filed: Sep. 20, 2024

Related U.S. Application Data
(60) Provisional application No. 63/584,367, filed on Sep. 21, 2023.

(51) Int. Cl. G06T 3/4007

(52) U.S. Cl. CPC G06T 3/4007

(57) ABSTRACT

The present invention describes methods and techniques to improve scintigraphic images obtained by using nuclear medicine techniques for diagnostic analysis. The present invention describes a method and technique to up-sample and down-sample nuclear medicine images that models photon counts and noise characteristics of an image at its target resolution.

### TECHNICAL FIELD

The subject matter described herein relates to methods and techniques for improving the quality of scintigraphic images. More particularly, the subject matter described herein relates to methods, systems, and techniques to up-sample and down-sample nuclear medicine images that model photon counts and noise characteristics of an image at its target resolution.

### BACKGROUND

Image resizing is a common image processing operation to resample the image from one grid size to another. When the image is up-sampled (the pixel density increases) a choice of interpolation methods may be applied, the most common of which are nearest neighbor, bilinear, bicubic, and b-spline. When the image is down-sampled (the pixel density decreases), neighboring pixels may be averaged. In almost all imaging modalities, the process of resizing may not substantially alter the natural semantic and noise characteristics of the image. However, in the case of nuclear medicine scintigraphy, where the native image unit is the number of detected events (photon counts), Poisson counting statistics play a visually perceivable and mathematically significant role in the image noise. As dictated by Poisson counting statistics, the variance is the signal, which is equal to the mean (expected true counts) of the sample, and hence the relative noise decreases as the square root of the mean counts. Total photon counts, and thus photon density, need to be conserved if downstream operations are dependent on accurate noise modeling. Since resizing intrinsically modifies the number of pixels and pixel spacing, the resulting resized image should reflect the splitting or joining of counts from the original image in the target image.

Further, scintigraphic image quality is directly related to the number of photons captured by the camera, which is dependent on the following factors: camera efficiency, amount of radioactivity in the field of view, and image acquisition time. Increasing any of these factors will result in increased count statistics and hence reduced image noise. However, any such increase comes at a cost. Increasing camera sensitivity requires more imaging hardware, or collimators that favour sensitivity over spatial resolution. Increasing radioactivity is at the peril of patient exposure to ionizing radiation and cost. Finally, increasing image acquisition time is at the expense of patient comfort, risk of patient motion, and reduced clinical throughput. The present invention particularly relates to the prospect of increasing the effective sensitivity of the imaging system by post-processing the scintigraphic images to enhance their quality. Conventionally, image processing approaches to reduce image noise utilized low-pass filters, at the expense of image spatial resolution and signal to background contrast. While more advanced approaches have been proposed, very few have achieved clinical utility, with “Pixon” image enhancement being perhaps the rare exception. Pixon achieves a minor improvement in image enhancement equivalent to ˜20% boost in effective sensitivity improvement, by subjective visual assessment at the TOH clinic. Recently, the use of machine-learning image enhancement technologies has been proposed in the domains of PET with practical applications entering clinical routine. Relatively little similar efforts have been committed to planar scintigraphy.

Furthermore, the conventional SPECT projections instead of the 3D reconstructed SPECT volume can be advantageous: (1) when there is patient movement during the SPECT acquisition, which causes motion artefacts in the reconstructed SPECT volume, or (2) when a physician is not well trained in interpreting 3D SPECT images and wants to fall back on more familiar high-count planar images. Both of these cases can be encountered in ventilation/perfusion (V/Q scans). The first case also applies to 3D SPECT machines, which do not allow acquiring planar images.

There currently exist two methods for generating pseudo-planar images from single positron emission computed tomography (SPECT) acquisitions: (1) the summed angular method and (2) the reprojection method. In spite of inaccurate reproduction of diagnostic features, the pseudo-planar images from both methods are typically smoother than normally acquired planar images. The inventors of the present invention use AI to create realistic pseudo-planar images that resemble authentic planar scintigraphy images. Moreover, if there is motion during the SPECT acquisition, the reconstructed 3D SPECT volume will contain motion artefacts and thus, with the help of reprojection methods, any pseudo-planar derived thereof. Other pseudo-planar techniques use angle information in the DICOM images to make pseudo-planars at pre-defined angles (e.g., 0°, 45°, 90°, 135°, 180°, 225°, 270°, 315°), which can be incorrect if the patient is not properly positioned in the machine, or un-optimal for specific morphologies.

The current methodology of the present invention can incorporate a classification step to identify which SPECT projections correspond to the typical planar orientations (for example in ventilation perfusion scans, anterior, posterior, anterior obliques, posterior obliques, and laterals). Conventional AI methods for de-noising/count enhancement/dose reduction assume that the input image would be at the same spatial resolution as the output. Using the current resizing technique as disclosed in the present invention, photon count statistics and noise properties of nuclear medicine images are preserved, the spatial resolution of the SPECT images (which are usually acquired on a different spatial grid) before enhancing them with AI can be changed.

The present invention examines count enhancement of lung scintigraphic images using artificial intelligence. It encompasses three pivotal parts, each contributing to the overarching goal of improving V/Q scan image acquisition. The first part, a systematic review, establishes the necessity for renewing research into the use of AI in V/Q scans, identifying multiple possibly fruitful avenues. This exploration into existing literature underscored the potential of AI in enhancing the efficiency and accuracy of V/Q scans, setting the stage for subsequent empirical investigations. Recognising the need to resize SPECT to planar grid size and vice versa, the second part focuses on establishing accurate image resizing method that crucially preserve the inherent noise characteristics of V/Q scintigraphic images. This resizing technique is put into practice for preprocessing images for AI model training and validation in the final part. The final part involves developing an AI model to enhance low-count perfusion planar images to resemble a diagnostically relevant full count perfusion planar. This model holds promise to generate pseudo-planars from SPECT projection data and to reduce the duration of V/Q scans, thus improving the patient experience in nuclear medicine procedures. However, this work falls short of fully demonstrating the readiness of this approach for clinical application.

U.S. Pat. No. 10,349,087 describes procedures that modify pixel intensities in the image by resampling the pixel intensities according to a noise distribution generated by the up-sampling without receiving a noise estimate from an image compressor; however, this step resides within a larger method for compression and decompression of images without the constraints imposed by the physics of nuclear medicine imaging.

CN112532871A describes procedures that make use of non-integer sliding summation windows in order to respect the total areas of all sliding windows with that of the original image; however, the present invention does not impose such constraints on sliding window areas. Rather, the invention relates to the preservation of photon counts and noise characteristics of scintigraphic images.

The inventors of present invention propose a method and technique to up-sample and down-sample nuclear medicine images that models photon counts and noise characteristics of an image at its target resolution. The inventors of present invention propose an up-sampling method consisting of correcting the excess counts coming from typical interpolation (e.g., nearest neighbor, linear, etc.) by performing Poisson resampling. Poisson resampling consists in modifying the pixel/voxel values by resampling them from a Binomial distribution using the original pixel/voxel values, as the number of trials and the ratio of the target/original pixel/voxel area/volume constitutes the percentage of success. The inventors of the present invention also propose a down-sampling method consisting of applying a sliding summation window using a sliding window of ratio of the original/target pixel/voxel area/volume, rounded up to the nearest integer. If rounding occurs, then the resulting image is up-sampled to the target resolution and subjected to Poisson resampling to correct for the noise and photon properties. Further, the inventors of the present invention propose the prospect of machine learning (ML) based image count enhancement in scintigraphic images and speculate on its utility to shorten image acquisition times and to generate pseudo-planar images.

### SUMMARY

In one aspect of the present invention, a method for up-sampling digital scintigraphic images comprises the steps of:
a. receiving a digital scintigraphic image at an original resolution;
b. determining a target resolution for up-sampling the digital image;
c. applying a pixel interpolation algorithm to the original resolution image to create an upscaled image at the target resolution; and
d. correcting the photon and noise characteristics through Poisson resampling using the ratio of the target/original pixel/voxel areas/volumes.

In a second aspect of the present invention, the pixel interpolation algorithm is selected from the group consisting of nearest-neighbor, bilinear interpolation, bicubic interpolation, and Lanczos resampling.

In a third aspect of the present invention according to the first aspect, for use in pulmonary ventilation-perfusion (V/Q) scintigraphy examination.

In a fourth aspect of the present invention, a method for down-sampling digital images comprises the steps of:
a. receiving a digital scintigraphic image at an original resolution;
b. determining a target resolution for down-sampling the digital image;
c. wherein if the ratio of the original/target resolution is an integer value for all directions, then a sliding window of integer size original/target resolution ratio can be used to sum counts along the original image to produce the target image;
d. the resulting image from (c) is up-sampled to the target resolution using a pixel interpolation algorithm to create an upscaled image at the target resolution; and
e. the photon counts and noise characteristics of the resulting image from (d) are corrected with Poisson resampling using the ratio of the pixel/voxel areas/volumes of images (c) and (d);
wherein if the ratio of the original/target resolution is a non-integer value for any direction, then a sliding window is made by rounding up to the nearest integer of the ratio of the original/target resolution ratio. This will produce an image smaller than the target image.

In a fifth aspect of the present invention, the pixel interpolation algorithm is selected from the group consisting of nearest-neighbor, bilinear interpolation, bicubic interpolation, and Lanczos resampling.

In a sixth aspect of the present invention according to the fourth aspect, for use in pulmonary ventilation-perfusion (V/Q) scintigraphy examination.

In a seventh aspect of the present invention, it examines count enhancement of lung scintigraphic images using artificial intelligence. It encompasses three pivotal parts, each contributing to the overarching goal of improving V/Q scan image acquisition.

### BRIEF DESCRIPTION OF THE DRAWINGS

The subject matter described herein will now be explained with reference to the accompanying drawings of which:

FIG. 1 is a block diagram illustrating an exemplary image of naïve (A) up-sampling and (B) down-sampling operations on a 2×2 nuclear scintigraphy image.

FIG. 2 is a diagram illustrating an exemplary image of Imaging of the Data Spectrum Anthropomorphic Torso Phantom inside the Siemens Intevo Bold SPECT/CT.

FIG. 3 is a diagram illustrating a simulated full dynamic acquisition experiment conducted on a 256×256 grid size to create real and synthetic low-count images.

FIG. 4 is a diagram illustrating an Up-sampling experiment.

FIG. 5 is a diagram illustrating a Down-sampling experiment.

FIG. 6 is an illustrative example of the effect of the various up-sampling (A) and down-sampling (B) methods on image similarity with respect to real and synthetic scintigraphic images at approximately 105 kents.

FIG. 7 is a diagram illustrating evaluating similarity metrics SSIM and Log MSE using a dynamic phantom acquisition on six common 2D planar projections.

FIG. 8 is a diagram illustrating image similarity metrics for 64×64 images up-sampled to 256×256 with reference curves from the real data.

FIG. 9 is a diagram illustrating image similarity metrics for 256×256 images down-sampled to 64×64 with reference curve from the real data.

FIG. 10 is a diagram illustrating a comparison of overlap between confidence intervals of 64×64 and 128×128 to 256×256 for linear interpolation and linear interpolation with Poisson.

FIG. 11 is a diagram illustrating the method for generating pseudo-planar images from single positron emission computed tomography acquisitions by Resizing with Poisson Resampling Correction and/or Sliding Summation Window using AI de-noising/Count Enhancement Algorithm.

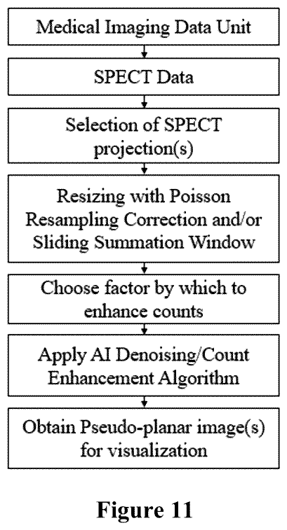

FIG. 12 illustrates a core architecture of count enhancement algorithm that simulates low count scintigraphic images from full count perfusion planar with 10% counts using Poisson resampling.

### DETAILED DESCRIPTION

The present invention relates to a method for up-sampling digital scintigraphic images comprising the steps of:
a. receiving a digital scintigraphic image at an original resolution;
b. determining a target resolution for up-sampling the digital image;
c. applying a pixel interpolation algorithm to the original resolution image to create an upscaled image at the target resolution; and
d. correcting the photon and noise characteristics through Poisson resampling using the ratio of the target/original pixel/voxel areas/volumes.

The present invention can be more readily understood by reading the following detailed description of the invention and included embodiments.

As used herein, the term “imaging” refers to techniques and processes used to create images of various parts of the human body for diagnostic and treatment purposes within digital health. X-ray radiography, Fluoroscopy, Magnetic resonance imaging (MRI), Computed Tomography (CT), Medical Ultrasonography or Ultrasound Endoscopy Elastography, Tactile imaging, Thermography Medical photography, and nuclear medicine functional imaging techniques, e.g., Positron Emission Tomography (PET), Dynamic Positron Emission Tomography or Single-photon Emission Computed Tomography (SPECT). Imaging seeks to reveal internal structures of the body, as well as to diagnose and treat disease.

As used herein, the term “Positron Emission Tomography (PET)” refers to a functional imaging technique that uses radioactive substances known as radiotracers or radionuclides to visualize and measure changes in metabolic processes, and in other physiological activities including blood flow, regional chemical composition, and absorption. Different tracers can be used for various imaging purposes, depending on the target process within the body. Commonly used radionuclide isotopes for PET imaging include carbon-11 (C-11), nitrogen-13 (N-13), oxygen-15 (O-15), fluorine-18 (F-18), rubidium-82 (Rb-82), copper-64 (Cu-64), zirconium-89 (Zr-89), and gallium-68 (Ga-68). The preferred radionuclide comprises Rb-82 (Rubidium-82) having a half-life of 75 seconds.

As used herein, the term “Single-Photon Emission Computed Tomography (SPECT)” refers to a nuclear medicine tomographic imaging technique using gamma rays and provides true 3D information. This information is typically presented as cross-sectional slices through the patient but can be freely reformatted or manipulated as required. The technique requires the delivery of a gamma-emitting radioisotope (a radionuclide) into the patient, normally through injection into the bloodstream. A marker radioisotope is generally attached to a specific ligand to create a radioligand, whose properties bind it to certain types of tissues. This allows the combination of ligand and radiopharmaceutical to be carried and bound to a region of interest in the body, where the ligand concentration is assessed by a gamma camera. SPECT agents include, iodine-123 (I-123), indium-111 (In-111), technetium-99m (Tc-99m), xenon-133 (Xe-133), thallium-201 (Tl-201), krypton-87m (Kr-81m), and gallium-67 (Ga-67).

As used herein, the term “Computed Tomography (CT)” refers to computerized x-ray imaging in which a beam of x-rays is aimed at a patient and rotated around the body, producing signals that are processed by the machine's computer to generate cross-sectional images of the body. These slices are called tomographic images and contain more detailed information than conventional x-rays. Once the machine's computer collects a number of successive slices, they can be digitally “stacked” together to form a three-dimensional image of the patient that allows for easier identification and location of basic structures as well as possible tumors or abnormalities.

As used herein, the term “Magnetic Resonance Imaging (MRI)” is a non-invasive imaging technology that produces 3D detailed anatomical images, which is used for disease detection, diagnosis, and treatment monitoring. MRI is based on technology that excites and detects the change in the direction of the rotational axis of protons found in the water that makes up living tissues.

As used herein, the term “diagnosis” refers to a process of identifying a disease, condition, or injury from its signs and symptoms. A health history, physical exam, and tests, such as blood tests, imaging, scanning, and biopsies can be used to help make a diagnosis.

As used herein, the term “therapy” or “therapeutic use” refers to the attempt to cure, improve, mitigate, treat and/or prevent disease and/or other conditions in humans. The term “therapy” also refers to pharmacotherapy or pharmacological therapy, which refers to the treatment of disease through the application of medications (drugs). It can be used to treat or prevent development of a disease, as well as to alleviate the pain and symptoms of the particular condition. Nuclear medicine therapy can be given with the help of radioisotopes like alpha emitters actinium-225 (Ac-225), astatine-211 (At-211), etc. and beta emitters such as lutetium-177 (Lu-177), lead-212 (Pb-212), etc.

As used herein, the term “Hybrid Molecular Imaging” refers to the fusion of two or more imaging technologies into a single, new form of imaging. This form is synergistic, which is more powerful than the sum of its parts. Hybrid imaging denotes image acquisitions on systems that physically combine complementary imaging modalities for an improved diagnostic accuracy and confidence as well as for increased patient comfort. The hybrid imaging combines the strengths of two imaging modalities in one imaging session to more accurately diagnose and locate diseases while increasing patient comfort. These are generated by superimposing two images at two different spatial scales: the low-spatial scale is obtained by filtering one image with a low-pass filter; the high spatial scale is obtained by filtering a second image with a high-pass filter. Examples of hybrid imaging modalities include PET-CT, SPECT-CT and PET-MRI.

As used herein, the term “dose” refers to the dose of a radionuclide required to perform imaging in a subject. The dose of a radionuclide to be administered to the subject ranges from 0.27 uCi to 270 mCi.

As used herein, the term “radionuclide” or “radioisotope” refers to an unstable form of a chemical element that releases radiation as it breaks down and becomes more stable. Radionuclides can occur in nature or can be generated in a laboratory. In medicine, they are used in imaging tests and/or in treatment.

As used herein, the term “image counts” refers to the number of radioisotope disintegrations acquired per unit of time by the PET scanner or SPECT scanner.

As used herein, the term “about” refers to a measurable value such as a parameter, an amount, a temporal duration, and the like, and is meant to encompass variations of and from the specified value, in particular variations of +10% or less, preferably +5% or less from the specified value, such variations are appropriate to perform in the disclosed invention. It is to be understood that the value to which the modifier “about” refers is itself also specifically, and preferably, disclosed.

As used in the specification of the present invention, the singular forms “a”, “an”, and “the” include plural references unless the context clearly dictates otherwise. Thus, for example, a reference to “a process” or “a composition” includes one or more process or composition, with one or more steps or elements of the type described herein and/or which will become apparent to those persons skilled in the art upon reading this disclosure and so forth.

An embodiment of the present invention provides a method of diagnosing lung diseases in a subject comprising performing a PET scan, PET/CT scan, dynamic PET scan, SPECT scan, PET/MRI scan, MRI scan, or combinations thereof by administering a PET agent, a SPECT agent, a contrast agent, and a dye or combinations thereof.

In another embodiment, the present invention provides imaging protocols for diagnosing lung diseases in a subject. Imaging protocols are based on PET, SPECT CT, MRI, or combinations thereof.

In another embodiment, the present invention provides the radionuclide or radioisotope is selected from PET or SPECT agent. The PET or SPECT agent can be radiolabeled with one or more ligands or can be administered without radiolabeling.

Another embodiment, the radionuclide or radioisotope is attached to the ligand before administration into the subject. The ligands are provided in a suitable dosage form and a radionuclide or radioisotope is attached to the ligand and then administered into the subject for imaging. The ligands according to the present invention are selected from but are not limited to Tetrofosmin, Sestamibi, and Fluorodeoxyglucose, or the like.

In almost all imaging modalities, the process of resizing may not substantially alter the natural semantic and noise characteristics of the image. However, in the case of nuclear medicine scintigraphy, where the native image unit is the number of detected events (counts), Poisson counting statistics play a visually perceivable and mathematically significant role in the image noise. As dictated by Poisson counting statistics the variance is the signal, which is equal to the mean (expected true counts) of the sample, and hence the relative noise decreases as the square root of the mean counts as shown in Eq. 1:

$$relative noise = \frac{standard - diviation}{mean} = \frac{\sqrt{mean}}{mean} = \frac{1}{\sqrt{mean}} \qquad Eq . 1$$

Total photon counts, and thus photon density, need to be conserved if downstream operations are dependent on accurate noise modeling. Since resizing intrinsically modifies the number of pixels and pixel spacing, the resulting resized image should reflect the splitting or joining of counts from the original image in the target image. Accurate accounting of counts, models what the image would have looked like had the image been acquired at the desired spatial grid and corresponding pixel spacing—including the magnitude of the noise in each pixel.

On one hand, naïve interpolation based up-sampling naturally gives rise to a larger sum of counts—due to an increased number of pixels—approximately by a factor of the up-sampling ratio. It is therefore essential to reduce the excess photon counts while maintaining the natural Poisson noise of scintigraphic images. In fact, White and Lawson (2015)[2] have demonstrated that Poisson resampling is the appropriate technique for artificially reducing counts in scintigraphic images. While this technique was originally intended to generate synthetic low-count scintigraphic images from high-count ones, this method can be reasonably repurposed for correcting the added collateral counts from up-sampling.

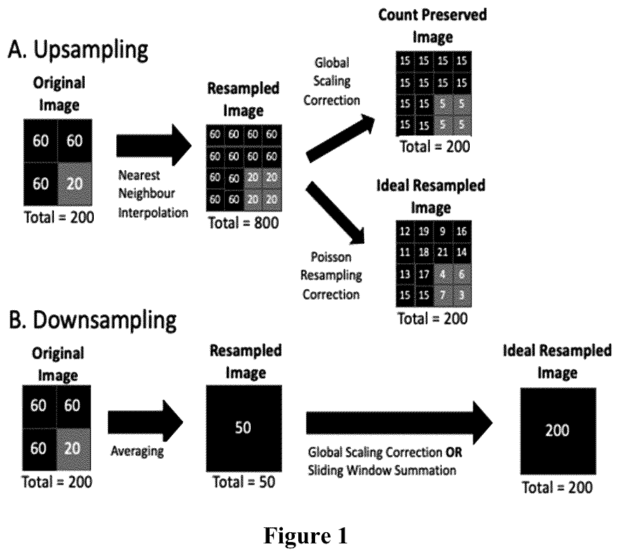

Down-sampling, on the other hand, is analogous to acquiring an image on a smaller spatial grid with a larger pixel size. Properly implemented, this operation effectively corresponds to the summation of photon counts with a sliding window whose size is given by the down-sampling ratio. This method will necessarily conserve count statistics and Poisson noise of the resulting image mimicking how a gamma camera would have aggregated photon counts within a larger pixel size. In more concrete terms, if we use the example of a 256×256 image to be resized to 128×128, the resulting image should be the same as if the image had been natively acquired on a 128×128 imaging grid (within the acceptable limits of random noise associated with two independent image samples). Each resulting pixel is thus expected to have 4 times more counts (the sum of 4 pixels sampling the same corresponding image space) on average than the original image pixel. Examples of up-sampling and down-sampling effects are demonstrated in FIG. 1 with a simple example of a 2×2 image.

An embodiment of the present invention relates to a method for down-sampling digital images, comprising the steps of:
a. receiving a digital scintigraphic image at an original resolution;
b. determining a target resolution for down-sampling the digital image;
c. applying a pixel interpolation algorithm to the original resolution image to create an up-scaled image at the target resolution;
d. correcting the photon and noise characteristics through Poisson resampling using the ratio of the target/original pixel/voxel areas/volumes;
e. the resulting image from (d) is up-sampled to the target resolution using a pixel interpolation algorithm to create an up-scaled image at the target resolution; and
f. correcting the photon counts and noise characteristics of the resulting image from (e) using Poisson resampling using the ratio of the pixel/voxel areas/volumes of images (e) and (d);
wherein if the ratio of the original/target resolution is an integer value for all directions, then a sliding window of integer size original/target resolution ratio can be used to sum counts along the original image to produce the target image; and
wherein if the ratio of the original/target resolution is a non-integer value for any direction, then a sliding window is made by rounding up to the nearest integer of the ratio of the original/target resolution ratio to produce an image smaller than the target image.

An embodiment of the present invention relates to a method for down-sampling digital images, wherein the pixel interpolation algorithm is selected from the group consisting of nearest-neighbor, bilinear interpolation, bicubic interpolation, and Lanczos resampling.

An embodiment of the present invention relates to a method for down-sampling digital images, wherein the method is used for pulmonary ventilation-perfusion (V/Q) scintigraphy examination.

An embodiment of the present invention relates to a method, wherein the method further comprises down-sampling digital images, comprising the steps of:
a. receiving a digital scintigraphic image at an original resolution;
b. determining a target resolution for down-sampling the digital image;
c. applying a pixel interpolation algorithm to the original resolution image to create an up-scaled image at the target resolution;
d. correcting the photon and noise characteristics through Poisson resampling using the ratio of the target/original pixel/voxel areas/volumes;
e. the resulting image from (d) is up-sampled to the target resolution using a pixel interpolation algorithm to create an up-scaled image at the target resolution; and
f. correcting the photon counts and noise characteristics of the resulting image from (e) using Poisson resampling using the ratio of the pixel/voxel areas/volumes of images (e) and (d);
wherein if the ratio of the original/target resolution is an integer value for all directions, then a sliding window of integer size original/target resolution ratio can be used to sum counts along the original image to produce the target image.

An embodiment of the present invention relates to a method for down-sampling digital images, wherein the method is used for pulmonary ventilation-perfusion (V/Q) scintigraphy examination.

An embodiment of the present invention relates to a method for image resizing, wherein the method for up-sampling digital scintigraphic image context preserves total image counts and maintains realistic image noise properties.

An embodiment of the present invention relates to a method for image resizing, wherein the images are harmonized by using the preprocessing step of neural network training.

An embodiment of the present invention relates to a method for image resizing, wherein the method provides a recipe for simple up-sampling and down-sampling of scintigraphic images to perform image rescaling operations.

An embodiment of the present invention relates to a method for image resizing, wherein if the ratio of the original/target resolution is a non-integer value for any direction, then a sliding window is made by rounding up to the nearest integer of the ratio of the original/target resolution ratio to produce an image smaller than the target image.

An embodiment of the present invention relates to a method of an image count enhancement, comprising the steps of;
a. a simulated low count image is generated from target diagnostic quality using Poisson resampling;
b. a low count image is input into a trained generator for image count enhancement;
c. the generator is trained using a machine learning algorithm; and
d. the Generator outputs a predicted simulated full count image.

An embodiment of the present invention relates to a method for image count enhancement, wherein the simulated low count input image was generated from diagnostic quality images with 10% of the counts using Poisson resampling.

An embodiment of the present invention relates to a method for image count enhancement, wherein the generator is a pix2pix architecture with a U-Net.

An embodiment of the present invention relates to a method for image count enhancement, wherein the pix2pix model employs two types of loss functions for training: generative adversarial loss (LGAN) and L1 loss.

An embodiment of the present invention relates to a method for image count enhancement, wherein the difference between predicted simulated full count image and target diagnostic quality images are minimized by one or more of the following loss functions: discriminator (GAN), L1, and perceptual.

An embodiment of the present invention relates to a method for image count enhancement, wherein one or more of the loss function L1, GAN, and perceptual losses are used to optimize the image generation process.

An embodiment of the present invention relates to a method for image count enhancement, wherein the generator output represents a predicted simulated full count image, which for training and validation was compared against the ground truth target diagnostic quality images. An embodiment of the present invention relates to a method for image count enhancement, wherein the method reduces the dose and image acquisition time.

An embodiment of the present invention relates to future research, which aims to diversify the dataset by adding data from multiple hospitals. This approach introduces a broader range of images from different patients, thereby enhancing the model's robustness, generalizability, and reducing overfitting. Additionally, the future research involves certified nuclear medicine clinicians in the evaluation of the process, which is crucial. This assessment can help to determine whether this process can distinguish between real and AI-enhanced images and offer insights into the model's real-world efficacy.

Pseudo-Planars from SPECT Acquisitions

The inventors of the present invention focus on refining the model to enhance image counts by varying degrees, not restricted to just 10% of the full-count perfusion planars. Utilizing both SPECT and planar data obtained for each patient, future models can effectively use SPECT data as low-count images, with corresponding full-count planar images serving as targets. These input-target pairs, derived from SPECT data captured on a 128×128 grid and planar images on a 256×256 grid, should be processed to ensure they are on a matching grid size. This can be achieved by up-sampling and down-sampling methods of resizing of scintigraphic images. To train and evaluate the use of image enhancement to generate pseudo-planar, a need exists to match the best angled projection (input) corresponding to the planar image (ground-truth). This can be achieved with a preprocessing step that first centers the center-of-mass (COM) in the images to ensure the lungs are centrally positioned in the image frame. Next, the SPECT projections can be co-registered with the full-count planar images to select the SPECT projection with the highest Pearson correlation as that with the most similar angle. Further, more sophisticated approaches to generating pseudo-planars from SPECT may leverage the flexibility of machine learning models to account for additional data, such as from multiple SPECT projections (from slightly different angles). By performing the process, it can provide the benefit of more count statistics, while compensating for view angles. Machine learning algorithms may be able to effectively compensate for the motion.

FIG. 1 is a block diagram illustrating an exemplary image of naïve (A) up-sampling and (B) down-sampling operations on a 2×2 nuclear scintigraphy image (original) with linear interpolation, showing the resulting images and incorrect total events. Numbers represent pixel intensity as event counts. Ideal resampled images are shown in FIG. 1, as would have resulted had the same pattern been sampled by an imaging system with the target pixel sizes. “Count-preserved images” obtained with a global scaling correction are contrasted with an “Ideal Resampled Image” as if it had been acquired by an imaging system with the target pixel sizes and local noise associated with the increased or decreased counts per pixel. Numbers represent pixel intensity as event counts in the corresponding pixel and rounded to the nearest integer.

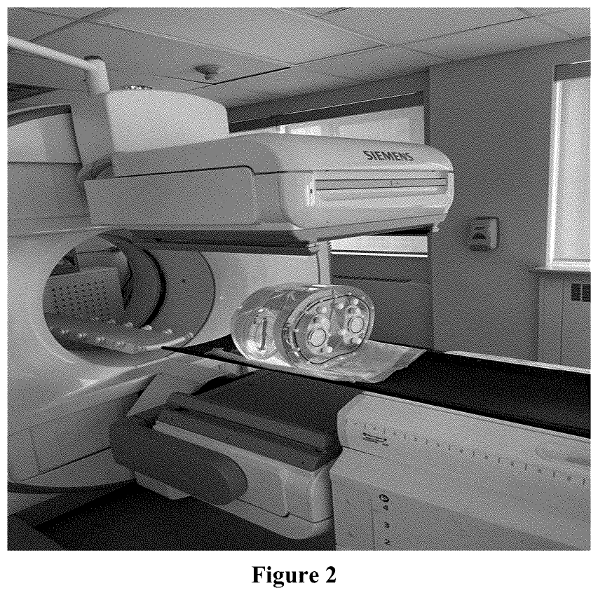

FIG. 2 is a diagram illustrating an exemplary image of Imaging of the Data Spectrum Anthropomorphic Torso Phantom inside the Siemens Intevo Bold SPECT/CT. The phantom, tailored with dimensions of 45×33 cm, represents anatomical structures pertinent to nuclear lung scans. Partially truncated lung cavities were filled with Styrofoam beads, simulating the low density of air-filled lung tissue. These cavities were then infused with a solution of 779 MBq of Technetium-99m (99mTc)-pertechnetate diluted with tap water, representing the space between the beads. To mimic soft-tissue attenuation, all other phantom cavities, including the thorax and liver, were saturated with tap water. This setup was devised to replicate the conditions of a pulmonary ventilation-perfusion (V/Q) scintigraphy examination.

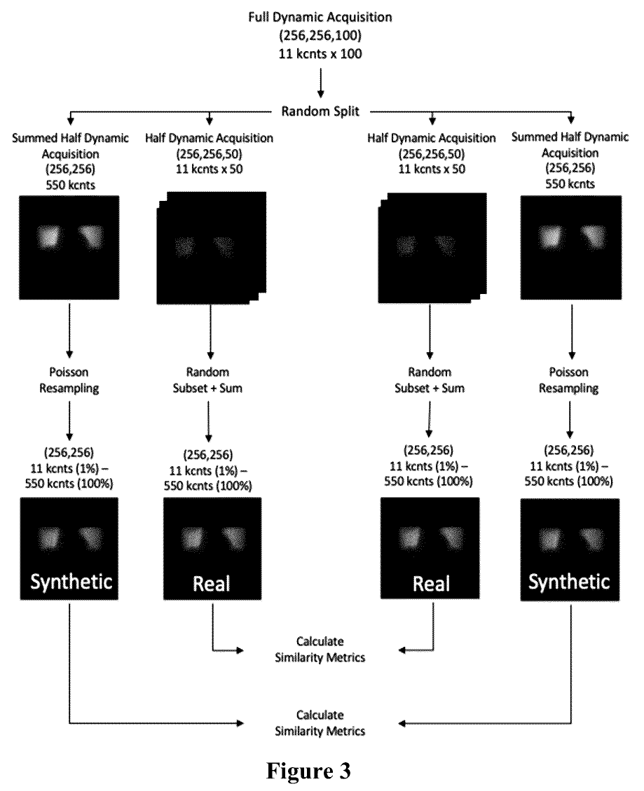

FIG. 3 is a diagram illustrating a simulated full dynamic acquisition experiment conducted on a 256×256 grid size to create real and synthetic low-count images. N corresponds to the number of frames in a dynamic acquisition. For illustrative purposes, N=25, 1<=N<=100.

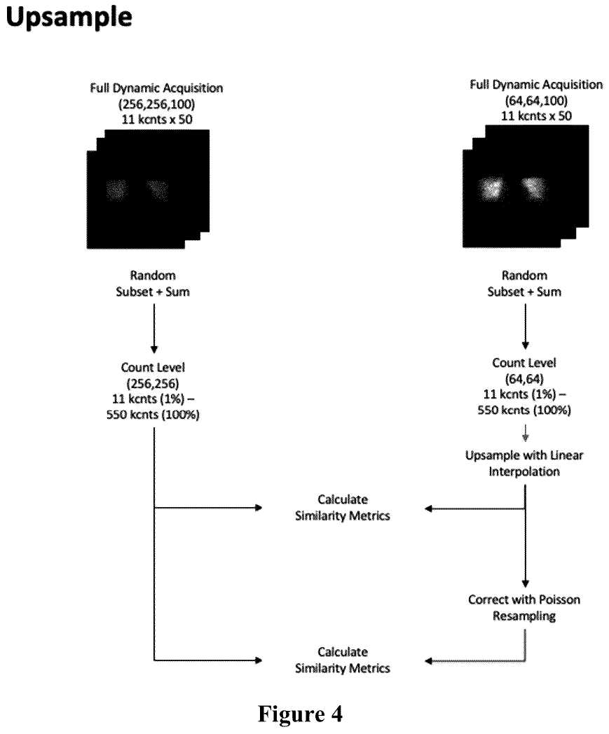

FIG. 4 is a diagram illustrating an up-sampling experiment: Example workflow resizing from a 64×64 to a 256×256 grid size using 2D phantom planar dynamic acquisition. The similarity metrics of both methods are compared against pre-determined reference similarity curves at the target (256×256) resolution. N corresponds to the number of frames in a dynamic acquisition. For illustrative purposes, N=25, 1<=N<=100.

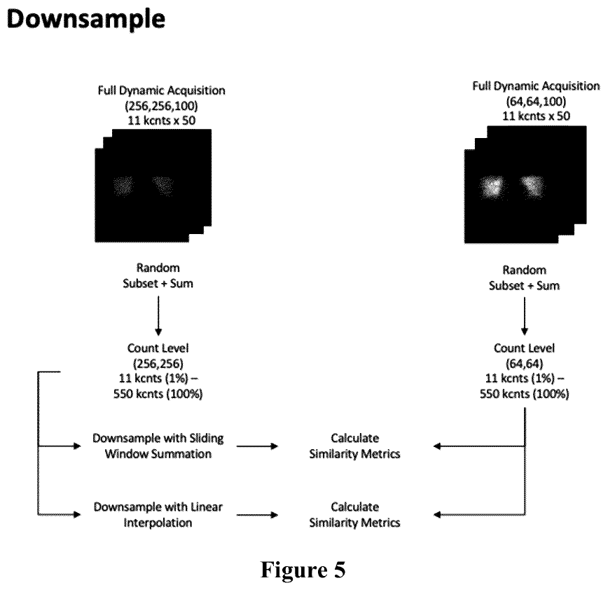

FIG. 5 is a diagram illustrating a down-sampling experiment: Example workflow resizing from a 256×256 to a 64×64 grid size using 2D phantom planar dynamic acquisition. The similarity metrics of both methods are compared against pre-determined reference similarity curves at the target (64×64) resolution. N corresponds to the number of frames in a dynamic acquisition. For illustrative purposes, N=25 where 1<=N<=100.

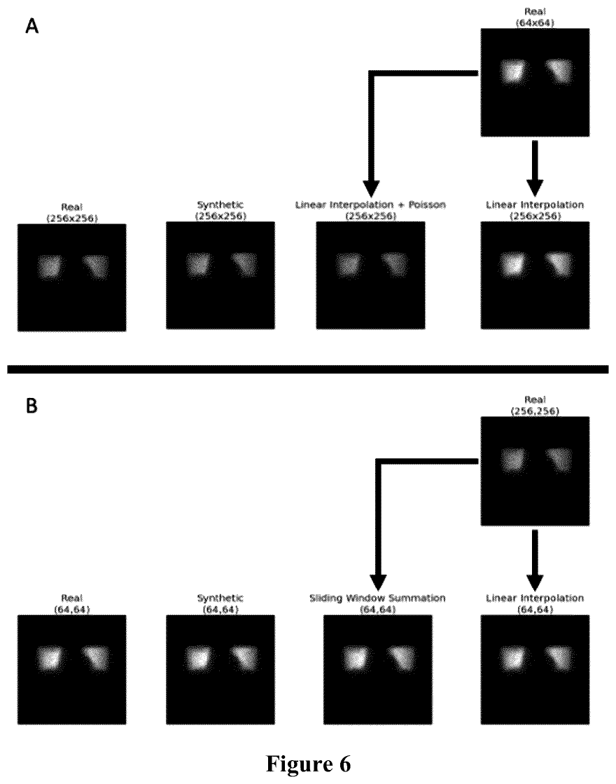

FIG. 6 is an illustrative example of the effect of the various up-sampling (A) and down-sampling (B) methods on image similarity with respect to real and synthetic scintigraphic images at approximately 105 kents. (A) From left to right: a Real (256×256) reference image reconstructed from the dynamic acquisition, a Synthetic image obtained from Poisson resampling of a 550 kents at the target spatial resolution (256×256), and the Real (64×64) up-sampled with linear interpolation and a Poisson resampling correction, and the Real (64×64) image up-sampled with only linear interpolation. (B) From left to right: a Real (64×64) reference image reconstructed from the dynamic acquisition, a Synthetic image obtained from Poisson resampling of a 550 kents at the target spatial resolution (256×256), the Real (256×256) down-sampled with sliding window summation, and the Real (256×256) down-sampled with only linear interpolation. All images were rendered in grayscale, with their intensity levels scaled according to their respective minimum and maximum values.

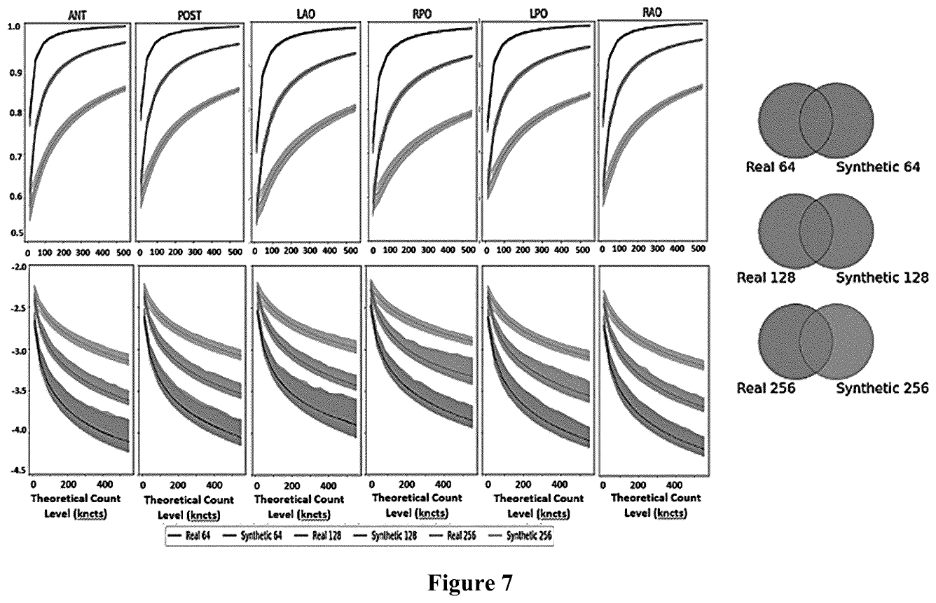

FIG. 7 is a diagram illustrating Evaluating similarity metrics SSIM and Log MSE using a dynamic phantom acquisition on six common 2D planar projections: ANT, anterior, LAO, left anterior oblique, LPO, left posterior oblique, POST, posterior, RAO, right anterior oblique, and RPO, right posterior oblique on spatial grids of 64, 128, and 256 pixels. Real curves are generated by summing pairs of scintigraphic images up to highest possible count value of 550 kents. Synthetic curves were created by synthesizing low-count versions of 550 kents using Poisson resampling correction.

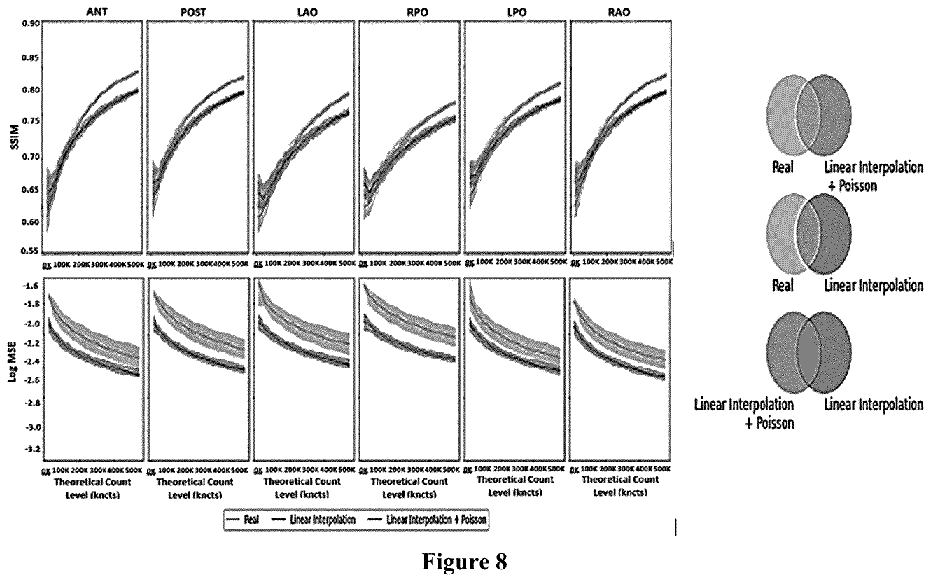

FIG. 8 is a diagram illustrating Image similarity metrics for 64×64 images up-sampled to 256×256 with reference curves from the real data.

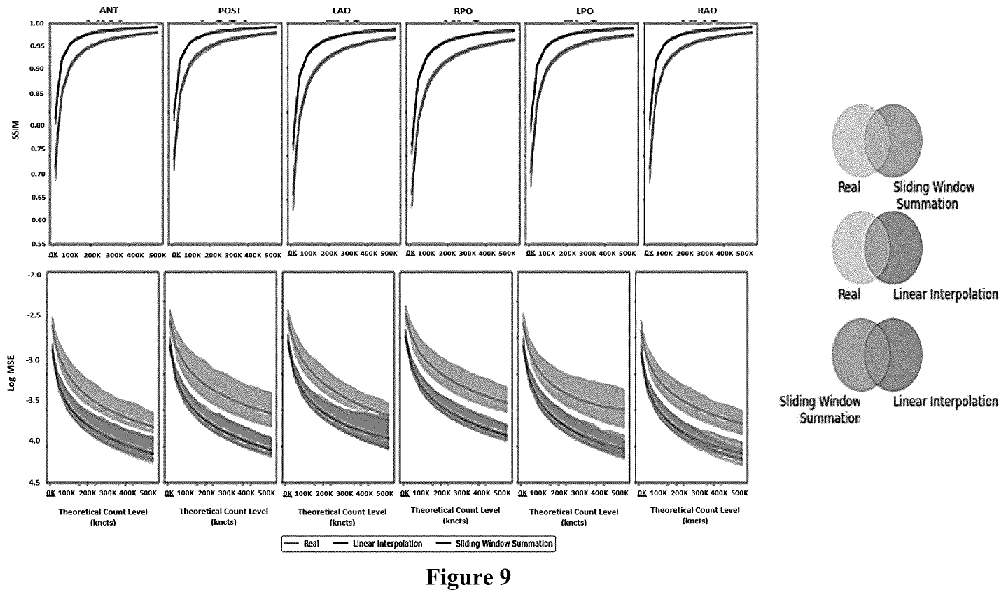

FIG. 9 is a diagram illustrating Image similarity metrics for 256×256 images down-sampled to 64×64 with reference curve from the real data.

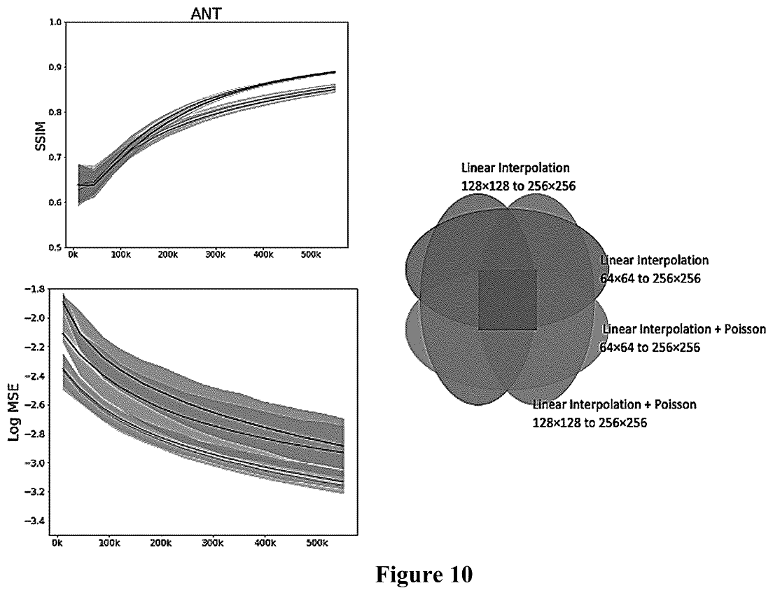

FIG. 10 is a diagram illustrating comparison of overlap between confidence intervals of 64×64 and 128×128 to 256×256 for linear interpolation and linear interpolation with Poisson. Currently, considering the immense work in artificial intelligence (AI) model development in medical imaging, AI developers often circumvent the high variability in image sizes in real-life clinical settings by forcing a model's input images to a fixed spatial grid under the assumption that these resized images reflect natively acquired ones on the destination spatial grid. In doing so, they often overlook the fact that by performing seemingly trivial resizing operations they may introduce false pixel noise representation into their images, with unknown consequences on their results.

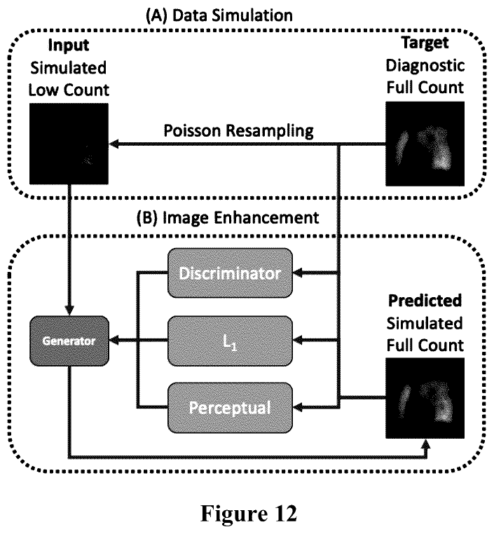

FIG. 12 illustrates a core architecture of count enhancement algorithm that simulates low count scintigraphic images from full count perfusion planar with 10% counts using Poisson resampling. Images are enhanced (B) using a pix2pix architecture with a U-Net generator. The difference between predicted and target images are minimized by the following loss functions: Discriminator (GAN), L1, and Perceptual.

The inventors of the present invention aim to compare traditional resizing with naïve linear interpolation against up-sampling with Poisson resampling corrections or down-sampling with sliding window summations. In particular, the present invention relates to evaluating the effect of each of these resizing techniques on the similarity of the resulting images to real images acquired at the target spatial grid using real phantom data. The study of the present invention demonstrates inaccuracies resulting from naively applying traditional image resizing methods in nuclear scintigraphy and establishes a robust standard for scintigraphic image resizing for future research and developments.

### Phantom

The present invention uses real planar scintigraphic images acquired using a physical phantom. The acquisition protocol is designed to emulate a pulmonary ventilation-perfusion (V/Q) scintigraphy exam using a specially designed Data Spectrum Anthropomorphic Torso Phantom with custom dimensions 45×33 cm that simulates anatomical structures and physiological parameters relevant to nuclear lung scans. The phantom includes partial (superiorly truncated) lung cavities which were filled with Styrofoam beads to emulate the low density of air-filled lung tissue. 779 MBq of Technetium-99m (^{99m}Tc)-pertechnetate were diluted with water, which is then used to fill the space between the Styrofoam beads in the lung cavities. All remaining phantom cavities (thorax and liver) are filled with tap water to emulate soft-tissue attenuation.

### Image Acquisition

Phantom images are acquired with a zoom factor of 1.45 at different spatial grids of 256×256, 128×128, and 64×64 with pixel spacings of 1.64 mm², 3.29 mm², and 6.59 mm², respectively. To easily generate planar images at various count levels, the inventors performed dynamic acquisitions comprised of 100 frames of 1 second duration each, resulting in about 11 kents/image for a total of 1.1 Ments over the whole dynamic acquisition. Dead time was <3% to minimize the impact of count pile up. Each of the aforementioned acquisitions are performed for the typical six views of a V/Q scan: anterior (ANT), posterior (POST), left anterior oblique (LAO), right posterior oblique (RPO), left posterior oblique (LPO), and right anterior oblique (RAO). All acquisitions were performed in quick succession (within 1 hour) to minimize radioactive decay between image sets.

Data for the study are acquired with a dual head Siemens Intevo Bold SPECT/CT using low energy high-resolution collimators. The energy window is set to 140±10 keV, corresponding to the photon peak energy of ^{99m}Tc.

### Establishing Reference Similarity Curves as a Function of Count-Level

A resized image of an object should be as similar to a scintigraphic image of that same object natively acquired at a target spatial resolution as any two images of the same object natively acquired at the target spatial resolution would be to each other. It is worth noting that neither image may serve as an absolute reference truth, as each image has some degree of inherent noise; each with a unique random permutation. Hence, the present invention evaluates measures of similarity throughout this work.

Time frames from the dynamic image series were randomly split and the images were summed to generate statistically independent images ranging from 11 to 550 kents. Various similarity metrics between the “full count” (550 kents) image and the reduced count (11-550 kents) images were calculated for: (1) two images acquired at the same spatial resolution, and (2) a resized image at a target spatial resolution and another natively acquired image at the same resolution. By summing combinations of randomly selected dynamic frames, the inventors of the present invention generate 1000 independent permutations of images with similar numbers of counts, and thus could bootstrap the reference similarity metrics to generate averages and confidence intervals. Reference similarity curves are generated as a function of count level between two images acquired at the same spatial resolution. Against these reference curves it could then compare similarity metrics curves between resized images and those acquired at the target spatial resolution. These reference lines and associated confidence intervals illustrate the highest degree of similarity achievable between two natively acquired images of the phantom at the same count level and spatial resolution. Ideally, the best resizing method would yield curves that most closely overlaps the reference curve.

To evaluate the proposed method with the highest achievable similarity of the target image, the inventors calculated the structured similarity index (SSIM) and the logarithm of the mean squared error (MSE). Prior to computing similarity metrics between pairs of images, each image is normalized to the maximum intensity pixel so as to be more sensitive to the statistics of the image (i.e., contrast, noise, texture, etc.) instead of the actual count values of the image, and be able to compare results between spatial resolutions.

Establishing Reference Similarity Curves with Synthetic Low-Count Images

In another embodiment, the present inventors also derived a second reference curve by first generating pairs of independent scintigraphic images with the highest possible count value given our dynamic acquisition (here, 550 kents) and then synthesizing low-count versions of them with Poisson resampling (FIG. 3). While it has already been demonstrated that Poisson resampling effectively yields low-count versions of high-count images that preserve the natural noise characteristics of single photon emission scintigraphy, it was decided to verify that two low-count Poisson resampled images would also be as similar to each other as two native low-count images. By demonstrating this, we can provide confidence that Poisson resampling is a reliable technique to simulate low-count images when dynamic acquisitions are not available—which is the case in most clinical settings—and that they can be combined with appropriately resized images from other spatial resolutions, as is done in super-resolution tasks.

### Up-Sampling Experiment

In another embodiment, the inventors of the present invention compared the similarity of up-sampled images with and without Poisson resampling corrections with the images of matched count level natively acquired on the target spatial resolution (FIG. 4). First, the inventor of the present invention reconstructed an image at a given count level at the lower spatial resolution by randomly selecting and summing the appropriate number of frames from the dynamic sequence. Second, the inventor of the present invention resized the image at the lower spatial resolution using linear interpolation to attain the higher target spatial resolution. The resized image was then rescaled by a factor corresponding to the increased pixel density (e.g., for 64×64 to 256×256 up-sampling the rescaling factor was (64/256)²= 1/16) so as to preserve the total number of counts in both images. Third, the inventor of the present invention applied a Poisson resampling correction to the resized image to simulate the counting statistical noise that would have been present at the target count level. Briefly, a Poisson resampling correction comprises resampling all pixels of the image using a binomial distribution where the initial pixel value constitutes the number of trials and the probability of success in our case is given the rescaling factor. Fourth, for each up-sampled image, the inventor of the present invention computed the image similarity metrics between it and another randomly reconstructed image natively acquired at the target spatial resolution. This process is repeated 1000 times with the dynamic acquisition images of the lower spatial grid to bootstrap confidence intervals of the image similarity curves as a function of count level.

### Down-Sampling Experiment

In yet another embodiment, the inventors of the present invention compared the similarity of down-sampled images with either linear interpolation or a sliding window summation method with images of the matched count level natively acquired on the target spatial resolution (FIG. 5). The inventor of the present invention started by reconstructing an image of a given count level by randomly selecting and summing the appropriate number of frames of the dynamic acquisition. The first method is to down-sample the images by the appropriate factor with linear interpolation to the lower spatial grid. The second method is a sliding window summation, which consisted of applying a 2×2 or a 4×4 non-overlapping sliding window across the higher resolution image and computing the sum of counts therein. The image similarity metrics are calculated between each down-sampled image and another randomly reconstructed native image at the target spatial resolution method. This process is also repeated with 1000 bootstrap samples to generate mean and confidence intervals as a function of count level.

### Results

### Visual Inspection of Up-Sampled and Down-Sampled Images

FIG. 4 illustrates the effect of the various up-sampling and down-sampling methods on image similarity with respect to real and synthetic scintigraphic images. As can be seen, up-sampling with naïve linear interpolation maintains the original increased contrast of high-to-low count areas of the lower resolution image that is less pronounced on the higher resolution image. The application of a Poisson resampling correction visually seems to restore the natural contrast of the image and re-introduce the typical Poisson noise of the real and synthetic images of the target higher resolution grid.

Down-sampling with either linear or a sliding window summation seems to yield images with similar contrast of high-to-low count areas. However, the noise of down-sampled with the sliding window appears more comparable to both real and synthetic images of the target lower resolution grid.

### Agreement Between Similarity Curves for Real and Synthetic Images

The reference curves for all similarity metrics from real and synthetic images (FIG. 7) overlapped nearly perfectly across all projections, count levels, and spatial resolutions, confirming that the synthesized (count reduced) images accurately modeled the actual count reduced images. A general finding also was that image similarity increased (i.e., higher SSIM and lower MSE) as the spatial resolution of the scintigraphic images decreased.

### Effect of Resizing Methods on Image Similarity

Up-sampling with naïve linear interpolation yielded image similarity curves that deviated significantly from the reference curves for real and synthetic data regardless of the source or target spatial grid, count level, and projection, as shown in FIG. 8. In particular, when compared with scintigraphic images natively acquired on the target spatial grid, up-sampled images with naïve linear interpolation produced higher SSIM and higher MSE than the reference curves for real and synthetic data. The deviations were more marked (i.e., less overlap of the confidence intervals) when up-sampling either from 64×64 or 128×128 to the highest grid of 256×256, FIG. 10, whereas there was more overlap of the similarity curves when up-sampling from 64×64 to 128×128. However, following the Poisson resampling correction, the similarity curves realigned with the reference curves both with respect to the mean and confidence intervals for each target spatial grid, count level, and projection.

With regards to down-sampling, the most striking result was that when resizing by a factor of 2 (i.e., from 256×256 to 128×128 or from 128×128 to 64×64), linear interpolation and sliding window summation methods yielded comparable similarity curves, both of which overlaid nearly perfectly on the reference curves. However, when down-sampling from 256×256 to 64×64, naïve linear interpolation yielded similarity curves that significantly deviated from the reference curves, as shown in FIG. 9. In this case, when compared with scintigraphic images natively acquired on the target spatial grid (64×64), down-sampled images with naïve linear interpolation resulted in lower values for SSIM as well as higher MSE with respect to the reference curves for real and synthetic data. Sliding window summation, on the other hand, produced perfect agreement with real and synthetic data reference curves.

It is understood to those skilled in the art that various details of the present invention disclosed may be changed without departing from the spirit and scope of the disclosure. Further, the foregoing technical description is for the purpose of illustration only, and not for the purpose of any limitation. Image resizing is a common process in medical imaging that many neglect to reflect on its finer nuances. The inventors of the present invention found that in the context of nuclear image scintigraphy, one must take care to adopt methods that preserve total image counts and maintain realistic image noise properties. This is crucial during the preprocessing step of neural network training where images are harmonized to a common grid size. The experiments of the present invention provide a recipe for simple up-sampling and down-sampling of scintigraphic images to enable the scientific community to properly perform image rescaling operations in practice.

The inventors of the present invention designed an image enhancement algorithm that converts simulated low count planar scintigraphic images to diagnostic quality planar scintigraphic images (FIG. 12). A low count image is akin to a low dose image since it is acquired for a shorter period. Inputs to the generator were simulated low count images that are generated from diagnostic quality images with 10% of the counts using Poisson resampling. The corresponding, original diagnostic planar image is treated as a gold standard image. The Generator output represents a predicted full count image, which for training and validation is compared against the ground-truth images. Corresponding low-count images are generated for each planar projection by simulating a 10% count image (i.e., a 90% count loss) using the method of Poisson resampling. The inventors of the present invention verified that these low-count simulated images maintained their structural integrity and no new defects are added or removed. This resulted in image pairs consisting of the original full count planar image (target) and the low-count simulation, which are the candidates for image enhancement (input). Since the target full count planar images are acquired on a 256×256 grid at TOH, the input was also simulated on a 256×256 grid.

The core architecture leverages the image-to-image translation model known as pix2pix, as detailed in section 2.4.2.2. The implementation closely aligns with the procedural framework. The pix2pix model employs two types of loss functions for training: generative adversarial loss (LGAN) and L1 loss. In this work, we wanted to see the effect of applying different loss functions on the generated image when using scintigraphic images as input. The first loss function was the L1 loss, a traditional approach in image processing. This loss function measures the absolute difference between predicted and target images, helping to maintain a similar global structure. L1 loss has demonstrated effectiveness in various medical imaging modalities, enhancing the structural integrity of predicted images. To complement L1 loss, a GAN was added, which is increasingly popular in medical image translation tasks and image enhancement tasks. Following Isola et al.'s method, adversarial training was applied to transfer low-count images to corresponding full count targets, enhancing the realism of predicted features. The inclusion of L1 loss alongside adversarial training is critical, as adversarial loss alone cannot guarantee structural similarity with target full-count images. The implementation of pseudo-planar images from simulated low count images has clinical implications. Simulated low count images were 10% of the counts in the diagnostic planar imaged, which is on the same order as SPECT raw data count level. Hence, the count enhancement method together with the image resizing methodology hold promise for generating high quality planar image from raw SPECT projection data. Such a tool is valuable for clinicians who have become accustomed to planar lung scintigraphy, especially those who may be hesitant to transition fully to SPECT. At The Ottawa Hospital, where the shift from performing both SPECT and planar imaging to exclusive SPECT imaging has already occurred, the introduction of pseudoplanar images is timely and relevant. While not all physicians will require pseudo-planar images as a matter of routine, these may be invaluable in cases of suspected patient motion or other imaging artefacts that can jeopardize the diagnostic accuracy of the reconstructed SPECT. As mentioned, the ability to reduce imaging times or the dosage of radiotracers through AI enhanced images addresses key patient concerns, such as discomfort and radiation exposure. Alternatively, this technology may be useful to further enhance full-count image data above current practice.

What is claimed is:

1. A method for up-sampling digital scintigraphic images, comprising the steps of:
a. receiving a digital scintigraphic image at an original resolution;
b. determining a target resolution for up-sampling the digital image;
c. applying a pixel interpolation algorithm to the original resolution image to create an upscaled image at the target resolution; and
d. correcting the photon and noise characteristics through Poisson resampling using the ratio of the target/original pixel/voxel areas/volumes.

2. The method of claim 1, wherein the pixel interpolation algorithm is selected from the group consisting of nearest-neighbor, bilinear interpolation, bicubic interpolation, and Lanczos resampling.

3. The method of claim 1, wherein the method is used for pulmonary ventilation-perfusion (V/Q) scintigraphy examination.

4. A method for down-sampling digital images, comprising the steps of:
a. receiving a digital scintigraphic image at an original resolution;
b. determining a target resolution for down-sampling the digital image;
c. applying a pixel interpolation algorithm to the original resolution image to create an upscaled image at the target resolution;
d. correcting the photon and noise characteristics through Poisson resampling using the ratio of the target/original pixel/voxel areas/volumes;
e. up-scaling the resulting image from (d) to the target resolution using a pixel interpolation algorithm to create an upscaled image at the target resolution; and
f. correcting the photon counts and noise characteristics of the resulting image from (e) using Poisson resampling using the ratio of the pixel/voxel areas/volumes of images (e) and (d);
wherein if the ratio of the original/target resolution is an integer value for all directions, then a sliding window of integer size original/target resolution ratio is used to sum counts along the original image to produce the target image; and
wherein if the ratio of the original/target resolution is a non-integer value for any direction, then a sliding window is made by rounding up to the nearest integer of the ratio of the original/target resolution ratio to produce an image smaller than the target image.

5. The method of claim 4, wherein the pixel interpolation algorithm is selected from the group consisting of nearest-neighbor, bilinear interpolation, bicubic interpolation, and Lanczos resampling.

6. The method of claim 4, wherein the method is used for pulmonary ventilation-perfusion (V/Q) scintigraphy examination.

7. The method of claim 1, wherein the method further comprises down-sampling digital images, comprising the steps of:
a. receiving a digital scintigraphic image at an original resolution;
b. determining a target resolution for down-sampling the digital image;
c. applying a pixel interpolation algorithm to the original resolution image to create an upscaled image at the target resolution;
d. correcting the photon and noise characteristics through Poisson resampling using the ratio of the target/original pixel/voxel areas/volumes;
e. up-sampling the resulting image from (d) to the target resolution using a pixel interpolation algorithm to create an upscaled image at the target resolution; and
f. correcting the photon counts and noise characteristics of the resulting image from (e) using Poisson resampling using the ratio of the pixel/voxel areas/volumes of images (e) and (d);
wherein if the ratio of the original/target resolution is an integer value for all directions, then a sliding window of integer size original/target resolution ratio can be used to sum counts along the original image to produce the target image.

8. The method of claim 7, wherein the method is used for pulmonary ventilation-perfusion (V/Q) scintigraphy examination.

9. The method of claim 1, wherein the method for up-sampling digital scintigraphic image context preserves total image counts and maintains realistic image noise properties.

10. The method of claim 1, wherein the images are harmonized by using the preprocessing step of neural network training.

11. The method of claim 1, wherein the method provides a recipe for simple up-sampling and down-sampling of scintigraphic images to perform image-rescaling operations.

12. The method of claim 7, wherein if the ratio of the original/target resolution is a non-integer value for any direction, then a sliding window is made by rounding up to the nearest integer of the ratio of the original/target resolution ratio to produce an image smaller than the target image.

13. A method of an image count enhancement, comprising the steps of;
a. generating a simulated low count image from target diagnostic quality using Poisson resampling;
b. inputting a low count image into a trained generator for image count enhancement;
c. training the generator using machine learning algorithm; and
d. the generator outputting a predicted simulated full count image.

14. The method of claim 13, wherein the simulated low count input image that were generated from diagnostic quality images with 10% of the counts using Poisson resampling.

15. The method of claim 13, wherein the generator is a pix2pix architecture with a U-Net.

16. The method of claim 15, wherein the pix2pix model employs two types of loss functions for training: generative adversarial loss (LGAN) and L1 loss.

17. The method of claim 13, wherein the difference between predicted simulated full count image and target diagnostic quality images are minimized by one or more of the following loss functions: discriminator (GAN), L1, and perceptual.

18. The method of claim 17, wherein the loss function L1, GAN, and perceptual losses are used to optimize the image generation process.

19. The method of claim 13, wherein the generator output represents a predicted simulated full count image comprising a comparison against the ground truth target diagnostic quality images.

20. The method of claim 13, wherein the method reduces the dose and image acquisition time.
